(19) United States
(12) Patent Application Publication
(10) Pub. No.: US 2020/0051533 A1
(43) Pub. Date: Feb. 13, 2020

(54) SYSTEM AND METHOD FOR DISPLAYING CONTENT IN ASSOCIATION WITH POSITION OF PROJECTOR

(71) Applicant: KOREA ELECTRONICS TECHNOLOGY INSTITUTE, Seongnam-si, Gyeonggi-do (KR)

(72) Inventors: Sung Hee HONG, Seoul (KR); Hoon Jong KANG, Goyang-si, Gyeonggi-do (KR); Choon Sung SHIN, Seoul (KR); Ji Soo HONG, Seoul (KR); Young Min KIM, Seoul (KR)

(21) Appl. No.: 16/339,909

(22) PCT Filed: Oct. 7, 2016
(86) PCT No.: PCT/KR2016/011244

§ 371 Date: Apr. 5, 2019

(30) Foreign Application Priority Data
Oct. 7, 2016 (KR) 10-2016-0129651

(51) Int. Cl. G09G 5/38; G09G 5/373

(52) U.S. Cl. CPC G09G 5/38; G09G 5/373; G09G 2340/0464; G09G 2340/045; G09G 2370/022; G09G 2354/00

(57) ABSTRACT

Provided are a system and a method for displaying content in association with a position of a projector. A method for displaying an image, according to one embodiment of the present invention, comprises identifying a position of an image output device, generating a partial image from a full image on the basis of the position of the image output device, and outputting the generated partial image by means of the image output device. As a result, since the image projected from the image output device changes in association with the position of the image output device, a more realistic AR/VR may be provided.

### TECHNICAL FIELD

The present disclosure relates to content display technology, and more particularly, to a display system and a method for providing a realist image.

### BACKGROUND ART

Augmented reality (AR) generally refers to technology for generating an image by synthesizing an image photographed by a camera with a virtual character by using computer graphics (CG). Accordingly, smart devices (smartphones, smart pads, or the like) are usually used for AR. However, since AR does not allow users to see images with their naked eyes and requires them to use some devices to see images, there is a problem that realism is reduced.

As a related-art method for allowing users to see CG images with naked eyes, there is a method of using a projector to provide a virtual screen. An AR effect can be achieved by playing a projector in a real space and adding a CG image.

However, a related-art projector has no correlation between a space for projecting and a projected image, and the space and the image are independent. That is, an image projected onto a screen and a direction of a projector are independently operated.

Specifically, when an “A” image shown in FIG. I is displayed on a screen S, the image may be displayed on the screen S as shown in FIG. 2 if a projector is oriented upward, may be displayed on the screen S as shown in FIG. 3 if the projector is oriented toward the center, or may be displayed on the screen S as shown in FIG. 4 if the projector is oriented toward a lower right side.

As described above, the method of projecting an image by a projector is useful only when an image is appreciated or a presentation is made, and may not be used to provide a realistic image like AR.

### DISCLOSURE

### Technical Problem

The present disclosure has been developed in order to address the above-discussed deficiencies of the prior art, and an object of the present disclosure is to provide a system and a method for displaying an image to provide a content in association with a pose of a projector, as a method for allowing users to experience virtual reality (VR)/AR with their naked eyes.

### Technical Solution

According to an embodiment of the present disclosure to achieve the above-described object, a method for displaying an image includes: identifying a pose of an image output device; generating a partial image from a full image on the basis of the pose of the image output device; and outputting the generated partial image through the image output device.

In addition, the pose of the image output device may be changed by a user.

in addition, the generating may further include: calculating a display region to which the image output devices outputs an image in the identified pose; and extracting a partial image corresponding to the calculated display region from the full image.

In addition, the method may include: adjusting a magnification of the full image; calculating a display region to which the image output device outputs an image in the identified pose; extracting a partial image corresponding to the calculated display region from the full image; and outputting the extracted partial image to the display region through the image output device.

In addition, the method may include: adjusting a size of the calculated display region; and extracting a partial image corresponding to the adjusted display region from the full image; and outputting the extracted partial image to the adjusted display region through the image output device.

In addition, the pose of the image output device may include a direction of the image output device.

In addition, the pose of the image output device may further include a position of the image output device.

In addition, the image output device may be an image projector.

In addition, the image output device may be of a mobile type.

According to another embodiment of the present disclosure, an image display system may include: an image output device configured to identify a pose of the image output device and to output a partial image; and a server configured to generate a partial image from a full image on the basis of the pose of the image output device, and to transmit the generated partial image to the image output device.

According to still another embodiment of the present disclosure, an image display method may include: identifying a pose of an image output device; transmitting the identified pose information to a server; receiving, from the server, a partial image generated from a full image on the basis of the pose of the image output device; and outputting the received partial image.

According to vet another embodiment of the present disclosure, an image display device may include: a detector configured to identify a pose of an image output device; a communication unit configured to transmit the identified pose information to a server, and to receive, from the server, a partial image generated from a full image on the basis of the pose of the image output device; and an output unit configured to output the received partial image.

### Advantageous Effects

According to embodiments of the present disclosure as described above, since an image projected by the projector changes in association with a pose of the projector, more realistic AR/VR can be provided.

In addition, according to embodiments of the present disclosure, the projector-pose-based image display can be applied to seeing various contents and entertainment, thereby boosting entertainment factors of users.

### DESCRIPTION OF DRAWINGS

FIGS. 1 to 4 are views illustrating a method for projecting an image by a related-art projector;

FIG. 5 is a view illustrating a magic lantern image display system according to an embodiment of the present disclosure;

FIG. 6 is a detailed block diagram of a content server illustrated in FIG. 5;

FIG. 7 is a detailed block diagram of a pico-projector illustrated in FIG. 5;

FIGS. 8 to 12 are views illustrating partial image display forms according to a pose of the pico-projector; and

FIG. 13 is a flowchart provided to explain a method for displaying an image according to another embodiment of the present disclosure.

### BEST MODE

Hereinafter, the present disclosure will be described in more detail with reference to the drawings.

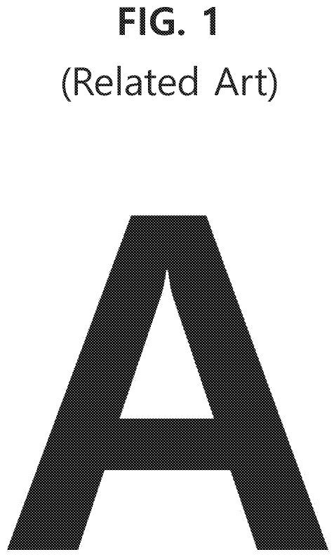

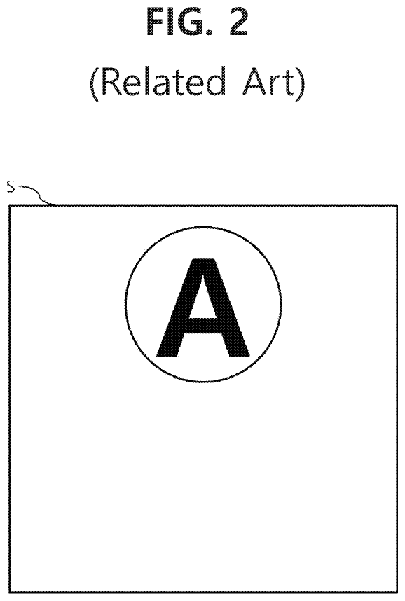

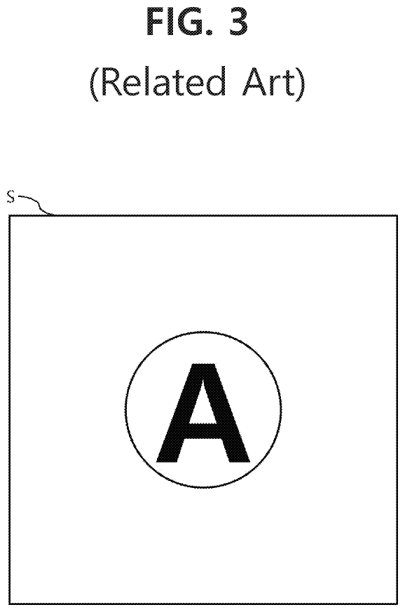

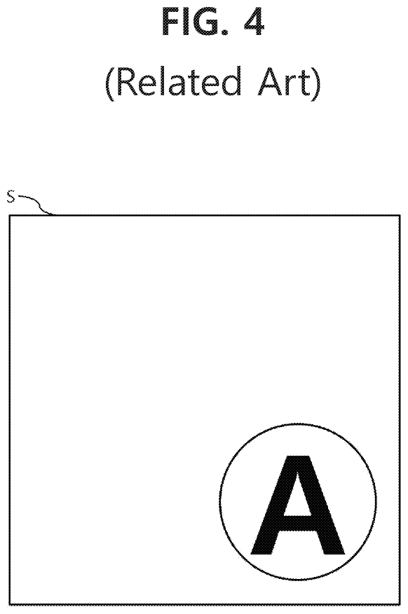

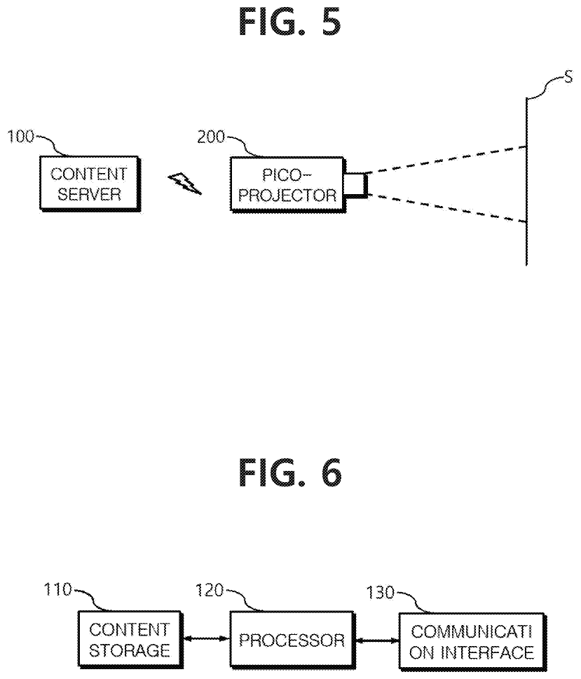

FIG. 5 is a view illustrating a magic lantern image display system according to an embodiment of the present disclosure. The “magic lantern image display system” according to an embodiment of the present disclosure (hereinafter, referred to as an “image display system”) is established by a content server 100 and a pico-projector 200 which operate in association with each other, as shown in FIG. 1.

The pico-projector 200 is a projector which projects an image onto a screen S, and is of a mobile type, which is so small and light that it can be carried by a user. Accordingly, a pose (a position (x, y, z) in a space and a projection direction (fan/tilt value)) of the pico-projector 200 may be changed/adjusted by a user.

The content server 100 is a server which contains a lot of contents, and generates a magic lantern image based on a content selected by the user and transmits the magic lantern image to the pico-projector 200. The pico-projector 200 projects the received magic lantern image onto the screen S.

The magic lantern image is a partial image corresponding to a part of a full image, and it is determined what part of the image is the magic lantern image, based on a pose of the pico-projector 200. That is, the content server 100 may generate the magic lantern image by extracting a partial image from the full image according to the pose of the pico-projector 200.

FIG. 6 is a detailed block diagram of the content server 100 illustrated in FIG. 5. The content server 100 includes a content storage 110, a processor 120, and a communication interface 130 as show in FIG. 6.

The content storage 110 stores a lot of contents, and the content in embodiments of the present disclosure refers to a full image used to generate a magic lantern image (hereinafter, referred to as a “partial image”).

The communication interface 130 connects communication with the pico-projector 200 to receive pose information and a user command from the pico-projector 200, and to transmit a partial image generated by the processor 120, which will be described below, to the pico-projector 200.

The processor 120 may generate a partial image by extracting a corresponding part from a full image stored in the content storage 110 according to pose information and a user command of the pico-projector 200, received through the communication interface 130.

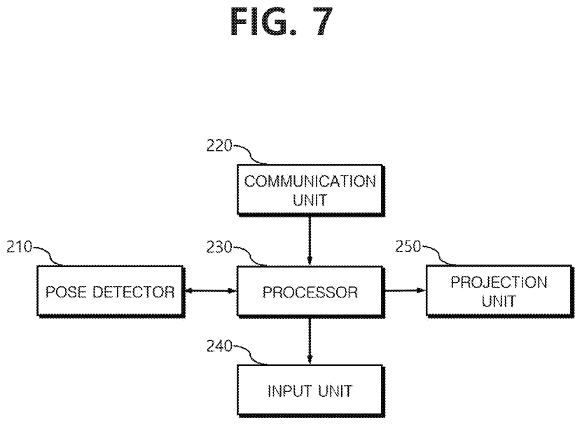

FIG. 7 is a detailed block diagram of the pico-projector 200 illustrated in FIG. 5. The pico-projector 200 includes a pose detector 210, a communication unit 220, a processor 230, an input unit 240, and a projection unit 250 as shown in FIG. 7.

The pose detector 210 includes various sensors necessary for detecting pose information of the pico-projector 200 in a space, and projection direction information, such as an angular speed sensor, an acceleration sensor, a gyro sensor, or the like.

The input unit 240 is a means for receiving an input of a user command, and the user command may include a command to select an image, a command to enlarge/reduce a display region, a command to zoom-in/zoom-out an image.

The communication unit 220 is a means for connecting communication with the content server 100, and the projection unit 250 is a means for projecting a partial image onto the screen S.

The processor 230 may transmit the pose information detected through the pose detector 210 and the user command inputted through the input unit 240 to the content server 100 through the communication unit 220.

In addition, the processor 230 may transmit a partial image received from the content server 100 through the communication unit 220 to the projection unit 250, and may cause the projection unit 250 to project the partial image onto the screen S.

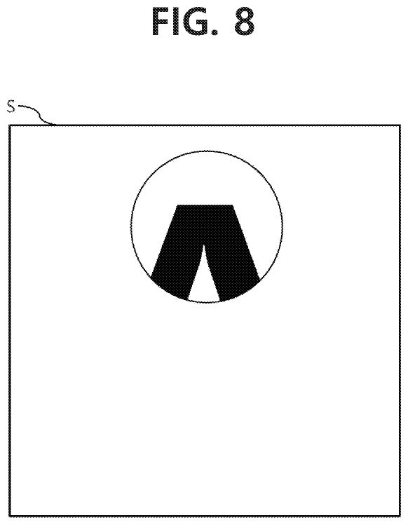

Hereinafter, a display form of a partial image according to a pose of the pico-projector 200 will be described in detail with reference to FIGS. 8 to 12, on the assumption that the “A” image illustrated in FIG. 1 is a full image.

FIG. 8 illustrates a partial image which is generated by the content server 100 and is projected through the pico-projector 200 when the pico-projector 200 is in such a pose that it can project an image onto a display region of an upper center of the screen S. It can be seen that only a partial image corresponding to an upper center region in the full image is displayed on the screen S.

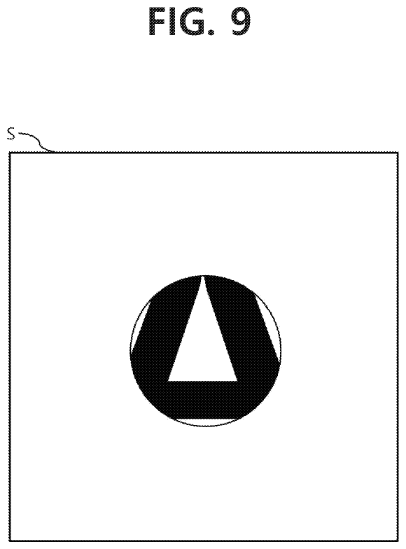

FIG. 9 illustrates a partial image which is generated by the content server 100 and is projected through the pico-projector 200 when the pico-projector 200 is in such a pose that it can project an image onto a display region of the center of the screen S. It can be seen that only a partial image corresponding to the center region in the full image is displayed on the screen S.

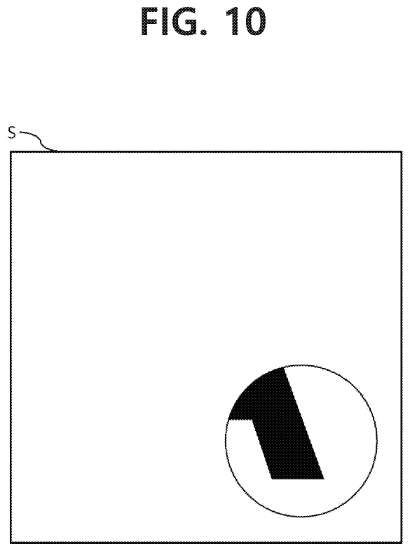

FIG. 10 illustrates a partial image which is generated by the content server 100 and is projected through the pico-projector 200 when the pico-projector 200 is in such a pose that it can project an image onto a display region of a lower right side of the screen S. It can be seen that only a partial image corresponding to a lower right side region in the full image is displayed on the screen S.

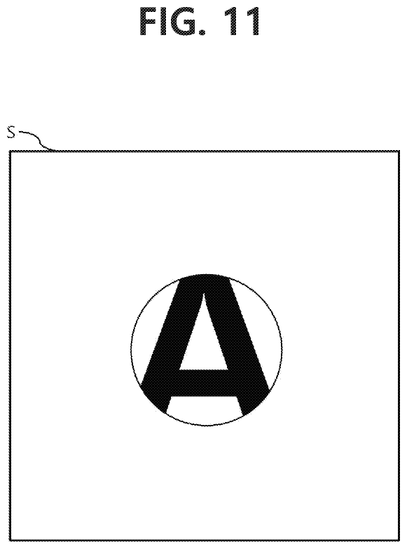

FIG. 11 illustrates a partial image which is generated by the content server 100 and is projected through the pico-projector 200 when the user inputs an image zoom-out command through the input unit 240 in the display state shown in FIG. 9.

The projected partial image may be an image which is generated by the processor 120 of the content server 100 adjusting (reducing) a magnification of the full image, and extracting a partial image corresponding to a display region calculated based on the pose of the pico-projector 200 from the full image.

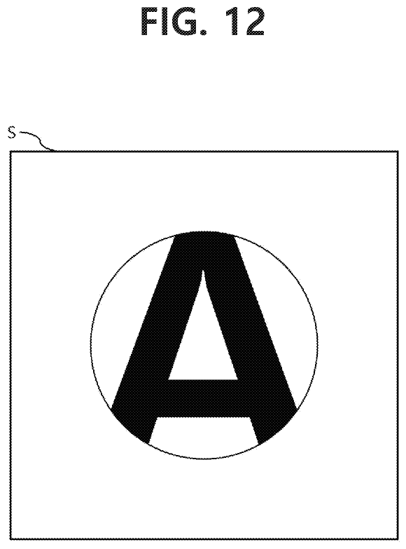

FIG. 12 illustrates a partial image which is generated by the content server 100 and is projected through the pico-projector 200 when the user inputs a display region enlarging command through the input unit 240 in the display state shown in FIG. 9.

The projected partial image may be an image which is generated by the processor 120 of the content server 100 enlarging the size of a display region calculated based on the pose of the pico-projector 200, and extracting a partial image corresponding to the enlarged display region from the full image.

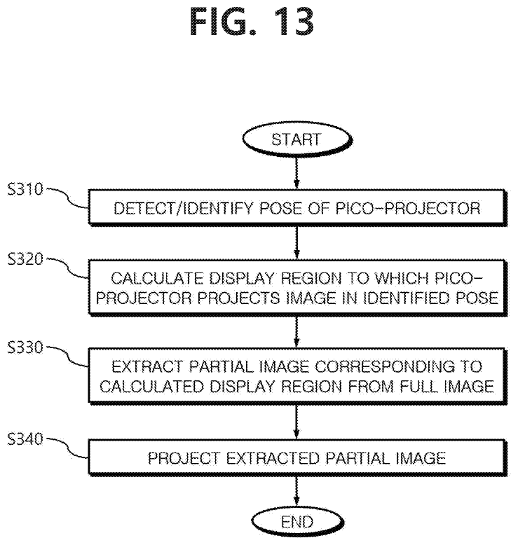

FIG. 13 is a flowchart provided to explain a method for displaying an image according to another embodiment of the present disclosure.

As shown in FIG. 13, the pico-projector 200 detects its pose (S310). The pose information detected at step S310 is transmitted to the content server 100 in real time.

Then, the content server 100 calculates a display region to which the pico-projector 200 will project an image, based on the pose received at step S310 (S320). That is, the content server 100 finds a display region at an upper center or on a lower right side of the screen S, and specifically, calculates center coordinates of the display region.

Next, the content server 100 extracts a partial image corresponding to the display region calculated at step S320 from a full image (S330). The partial image extracted at step S330 is transmitted to the pico-projector 200.

Then, the pico-projector 200 projects the partial image extracted at step S330 onto the screen S (S340). The partial image corresponds to a magic lantern image.

Up to now, preferred embodiments regarding the system and the method for displaying content in association with a pose of the projector have been described in detail.

In the above-described embodiments, it is assumed that the pico-projector 200 is a pico-projector of a mobile type, but this is merely an example, and the technical idea of the present disclosure can be applied to other types of pico-projectors.

Furthermore, the technical idea of the present disclosure can be applied to a case in which an image is not projected onto a screen S. In particular, AR can be implemented when an image is projected onto a wall surface.

The technical idea of the present disclosure may be applied to a computer-readable recording medium which records a computer program for performing the functions of the apparatus and the method according to the embodiments. In addition, the technical idea according to various embodiments of the present disclosure may be implemented in the form of a computer-readable code recorded on the computer-readable recording medium. The computer-readable recording medium may be any data storage device from which data can be read by a computer and which can store data. For example, the computer-readable recording medium may be a read only memory (ROM), a random access memory (RAM), a CD-ROM, a magnetic tape, a floppy disk, an optical disk, a hard disk drive, or the like. A computer-readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

1. A method for displaying an image, the method comprising:
identifying a pose of an image output device;
generating a partial image from a full image on the basis of the pose of the image output device; and
outputting the generated partial image through the image output device.

2. The method of claim 1, wherein the pose of the image output device is changed by a user.

3. The method of claim 1, wherein the generating further comprises:
calculating a display region to which the image output devices outputs an image in the identified pose; and
extracting a partial image corresponding to the calculated display region from the full image.

4. The method of claim 3, comprising:
adjusting a magnification of the full image;
calculating a display region to which the image output device outputs an image in the identified pose;
extracting a partial image corresponding to the calculated display region from the full image; and
outputting the extracted partial image to the display region through the image output device.

5. The method of claim 3, comprising:
adjusting a size of the calculated display region; and
extracting a partial image corresponding to the adjusted display region from the full image; and
outputting the extracted partial image to the adjusted display region through the image output device.

6. The method of claim 1, wherein the pose of the image output device comprises a direction of the image output device.

7. The method of claim 6, wherein the pose of the image output device further comprises a position of the image output device.

8. The method of claim 1, wherein the image output device is an image projector.

9. The method of claim 1, wherein the image output device is of a mobile type.

10. An image display system comprising:
an image output device configured to identify a pose of the image output device and to output a partial image; and
a server configured to generate a partial image from a full image on the basis of the pose of the image output device, and to transmit the generated partial image to the image output device.

11. An image display method comprising:
identifying a pose of an image output device;
transmitting the identified pose information to a server;
receiving, from the server, a partial image generated from a full image on the basis of the pose of the image output device; and
outputting the received partial image.

12. An image display device comprising:
a detector configured to identify a pose of an image output device;
a communication unit configured to transmit the identified pose information to a server, and to receive, from the server, a partial image generated from a full image on the basis of the pose of the image output device; and
an output unit configured to output the received partial image.
